(19) United States
(12) Patent Application Publication
(10) Pub. No.: US 2012/0064209 A1
(43) Pub. Date: Mar. 15, 2012

(54) Protein Ingredient Selection and Manipulation for the Manufacture of Snack Foods

(75) Inventors: Andres Victor ARDISSON-KORAT, Dallas, TX (US); Chien-Seng HWANG, Frisco, TX (US); James William STALDER, Dallas, TX (US)

(73) Assignee: FRITO-LAY NORTH AMERICA, INC., Plano, TX (US)

(21) Appl. No.: 12/882,709

(22) Filed: Sep. 15, 2010

(51) Int. Cl. A23J 1/20; A21D 8/02; A23P 1/12; A21D 13/00

(52) U.S. Cl. 426/334; 426/559

(57) ABSTRACT

Methods for the incorporation of dairy proteins into extruded snack products to provide a good source of protein are presented. In a first aspect, direct expanded, puffed products are obtained by selecting at least one filtered protein derived from milk and controlling unwanted reactions with one or more expansion controlling agents. Through the addition of expansion controlling agents such as a calcium carbonate, the thermally-treated, dairy protein-containing dough surprisingly results in a crunchier puffed snack food product. In a second aspect, the present invention provides for the manipulation of whey protein by ensuring the protein is denatured prior to combining with additional dry ingredients to form a sheetable whey-based dough suitable for cold extrusion-type processes.

### BACKGROUND OF THE INVENTION

1. Technical Field

The present invention relates to the incorporation of certain protein ingredients into snack food products. In particular, the invention involves the use of dairy-based proteins for extruded and baked snack food products.

2. Description of Related Art

Methods taking advantage of the versatility of rice to form crispy, light and convenient puffed snack food products have long been known; however, the production of similar snack products incorporating and maintaining healthy amounts of proteins has proven more challenging. To a large extent, this is due to the rigorous dehydration steps involved with the manufacture of snack foods that can lead to finished product defects such as excessive, undesired browning caused by Maillard reactions. Resulting browning tends to correlate with the severity of the heat treatments. In addition, it is also generally known that milk containing products are sensitive to heat. This phenomenon tends to be especially problematic when producing products by direct expansion, which requires high temperatures and pressures.

The challenge of working with proteins is also seen when working with lower temperatures such as those involved during cold extrusion. Many ongoing attempts to incorporate proteins into extruded snack products focus on the use of whey proteins for incorporation into food products rather than dairy products containing high amounts of casein. Whey is desirable in part due to its economic advantage relative to high casein fractions, as it is a byproduct of the cheese manufacturing process. However, whey is also known to produce adverse textural effects and can be difficult to incorporate into doughs. For example, whey contains a multitude of reactive side groups that yield sticky doughs, which makes it difficult to incorporate into food products made from doughs such as pretzels or any other product manufactured using cold extrusion processes.

Consequently, some proteins, such as those that are derived from dairy, require some form of further manipulation for easier handling. In light of the difficulties of cooking with protein containing products, there is a general preference in the industry for the use of carbohydrates rather than proteins. However, it remains desirable to have methods for modifying proteins to perform in a more desired way and for controlling the direct expansion of protein-containing snack food products given the presence of any non-reducing sugars such as lactose in foods.

Accordingly, there is a need for alternative methods of making snack food products that incorporate proteins and for controlling the undesired browning caused by Maillard reactions in the creation of direct expanded and/or baked snack foods. There is also a need for methods of manipulating certain proteins derived from dairy products such that there is a desirable increase in product expansion and porosity. In particular, there is a need for manipulating proteins containing lactose in order to better control and utilize these products for expanded and extruded products. Ideally, such methods should be economical and should utilize equipment common to the food processing industry. The present invention solves these problems and provides the advantage of increased health benefits and nutrition as well as the delivery of superior finished product sensory attributes.

### SUMMARY OF THE INVENTION

The present invention generally provides for an extruded snack food product comprising an efficacious dose of proteins. In a first aspect of the present invention, the protein-based dough undergoes high temperatures and high pressure processing to create a direct expanded snack food product. Specifically, a filtered dairy protein component is combined with at least one starch for introduction into an extruder for direct expansion. Suitable dairy products include, for example, microfiltered and ultrafiltered dairy products. In one embodiment, a Micellar casein is selected for incorporation into a direct expanded product. In another embodiment, a milk protein isolate (MPI) is selected. Preferably, a selected MPI comprises at least about 85% protein. In one embodiment, the MPI comprises between 1.7-2.0% lactose. In another embodiment, the MPI comprises no less than about 1.7% lactose. In further embodiments, the protein component further comprises a soy protein isolate. In one embodiment, the protein component comprises between 0 to 70% of a soy protein isolate. In one embodiment, the protein component comprises a milk protein isolate and a soy protein isolate in a ratio of 50:50. Generally, raw mixes of the present invention comprise at least 30% protein to produce base extrudates before seasoning.

In another embodiment, to improve expansion and texture of a direct expanded product and to reduce unwanted browning due to the inclusion of higher amounts of lactose, a porous calcium carbonate is introduced into the dry mix to enable the creation of products with small air cells that render dense, foamy textures. In other embodiments, the processing conditions can be further manipulated to increase expansion through the use of chelating agents to disrupt the matrix of the casein micelle and acids to lower the pH and impact the structure of the proteins.

In a second aspect in the incorporation of proteins into expanded snack food products, a protein-based dough undergoes cold extrusion or a cold type of extrusion to form a snack product such as a pretzel. In particular, the manipulation and control of a whey protein is achieved by taking advantage of the denaturated state of whey protein within a water-based solution in order to mitigate stickiness. By alleviating the tendency of whey proteins to bind with and compete for water, the present invention provides for a more cohesive dough. Preferably, a whey protein source is denatured prior to its combination with dry ingredients in the formation of a dough.

In one embodiment, by heating the whey in a water-based solution to substantially denature the protein, the structure of the protein is sufficiently changed to reduce its functionality. As a result, it is believed that its molecular weight is able to better hold water without producing any of the stickiness typically observed when working with whey. In another embodiment, by soaking an already denatured whey protein source, a similar cohesive dough is formed by breaking down the protein source into one soft enough to allow for combination with the additional dry ingredients. In further embodiments, denatured whey protein can also be combined with additional protein sources, whether or not denatured, and formed into a cohesive dough for forming extrusion. In one embodiment, for example, the denatured protein is combined with a soy protein isolate. In another embodiment, the denatured protein can be combined with a milk protein isolate. Dry ingredients as typically used to create snack foods using cold extrusion processes are also incorporated into the dough. In further embodiments, dry ingredients such as multigrain, whole grain and fiber ingredients are combined with the whey protein component in forming the dough. The cohesive doughs created by the present invention can then be extruded and cut into a snack product, which may be seasoned and packaged prior to consumption.

The methods of the present invention result in a snack product having at least 5 grams of a good source of protein per 1 ounce serving. The preferred source of protein of the present invention is a milk or dairy-derived product. In one embodiment, the dairy source is a whey product.

Other aspects, embodiments and features of the invention will become apparent from the following detailed description when considered in conjunction with non-limiting examples.

### BRIEF DESCRIPTION OF THE DRAWINGS

The novel features believed characteristic of the invention are set forth in the appended claims. The invention, itself, however, as well a preferred mode of use, further objectives and advantages thereof, will be best understood by reference to the following details description of illustrative embodiments when read in conjunction with the accompanying drawings, wherein:

FIG. 1 depicts a flowchart of the overall method used in a first aspect of the present invention.

FIG. 2A depicts a cross sectional view of a direct expanded MPI product without calcium carbonate in accordance with the first aspect of the present invention.

FIG. 2B depicts a cross sectional view of a direct expanded MPI product with calcium carbonate in accordance with the first aspect of the present invention.

FIG. 3 is a graphical representation of comparing the variation of the cell size measurements of the samples, shown in FIGS. 2A and 2B.

FIG. 4A illustrates a direct expanded product manufactured using the processing conditions of the first aspect of the present invention.

FIG. 4B illustrates a cross sectional view of the product depicted in FIG. 4A.

FIG. 5A illustrates a direct expanded product containing a MPI without calcium carbonate in accordance with the first aspect of the present invention.

FIG. 5B is a cross sectional view of the product depicted in FIG. 5A.

FIG. 6A illustrates a direct expanded product containing a micellar casein with no calcium carbonate in accordance with the first aspect of the present invention.

FIG. 6B is a cross sectional view of the product depicted in FIG. 6A.

FIG. 7 depicts a flowchart of the overall method used in a second aspect of the present invention relating to cold extruded products.

FIG. 8A depicts a flow chart of one embodiment used in manufacturing cold extruded products comprising a dairy protein.

FIG. 8B depicts a flow chart of another embodiment used in manufacturing cold extruded products comprising a dairy protein.

### DETAILED DESCRIPTION

Generally, the present invention provides for the incorporation of proteins that are otherwise difficult to incorporate into shelf-stable, ready-to-eat snack products and methods of manipulating select proteins to produce improved doughs and appealing snack food products having desirable flavor profiles and textures. Resulting food products comprise up to and at least 5 grams of a good source of protein per serving. While the invention is described herein in terms of a batch process, one skilled in the art, when armed with this disclosure, can easily determine means for mass or large-scale commercial production. Unless otherwise indicated, percentages, parts, ratios and the like recited herein are by weight.

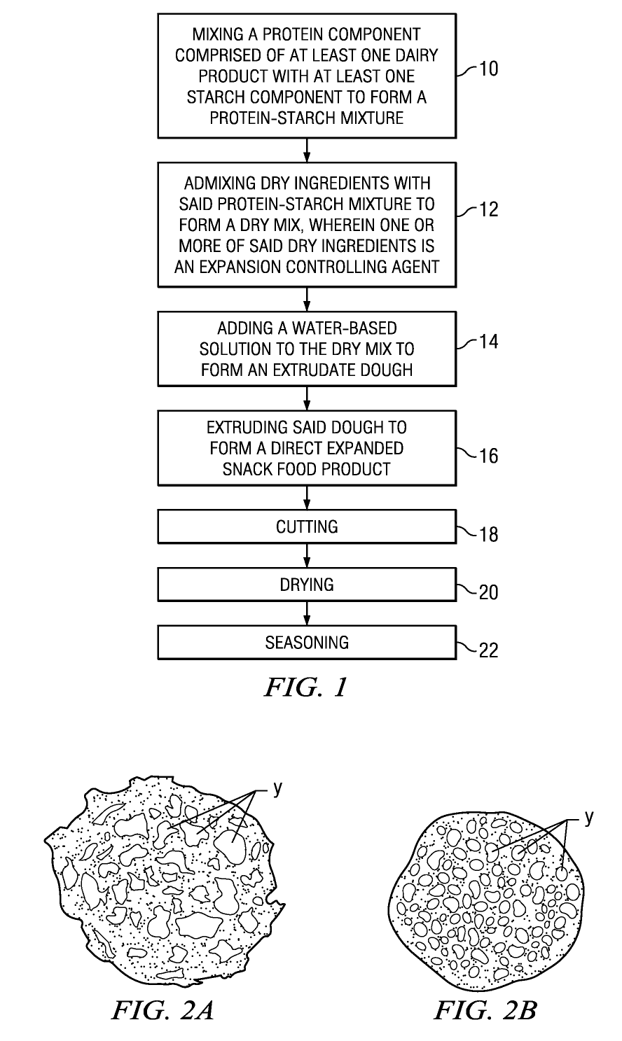

A first aspect of the present invention is generally depicted in FIG. 1 as it relates to the inclusion of a protein component for incorporation into a direct expanded, or puffed, snack food product. Traditionally, direct expansion of foods requires high temperatures and high pressures and generally starches such as corn meal are preferred due to their expansion properties. However, in the present invention, a protein component comprised of at least one dairy product is mixed with the starch component to form a protein-starch mixture 10. While the sugars of dairy products typically produce extrudates having a burned dairy flavor, dark brown color, glassy texture, large cell bubbles and poor expansion, it has been found that the methods of the present invention provide for the manipulation of proteins sufficient to allow for the improved workability both in terms of handling the dough and in producing an end result having improved expansion, texture and taste. This is especially significant when working at the temperatures and pressures high enough to product a puffed or direct-expanded snack food product. Applicants believe that the filtered milk proteins disclosed herein provide for superior flavor and texture in direct expanded products in part because the larger molecule size of these proteins may provide for more heat stability and greater resistance to burning within the environment of a twin screw or high temperature extruder. Moreover, the physical separation principles underlying the microfiltration and ultrafiltration processes used in creating these products may also contribute to the superior flavor profile and an improved, crunchier texture and mouth feel of direct expanded products. Thus, in one embodiment, the dairy product selected is a filtered dairy product, defined as one that has undergone a gentle physical purification process driven by a pressure gradient, in which a membrane fractionates components as a function of their size and structure, resulting in the separation of protein with retention of its characteristics. The filtration process further results in the removal of portions of lactose without any chemically strong acid or caustic treatments. For purposes of the present invention, a microfiltered dairy product refers to a filtered dairy product that retains casein, allowing for a change in the fraction ratio or casein to whey. In one embodiment, the microfiltered dairy product of the present invention contains a casein to whey ratio of about 90:10. An ultrafiltered dairy product refers to a filtered dairy product that retains both casein and whey fraction, with concurrent removal of lactose and minerals. In one embodiment, the ultrafiltered dairy product of the present invention contains a casein to whey ratio of about 80:20.

In one embodiment, a microfiltered (MF) product is selected as a suitable dairy product for mixing with a starch component 10 for creation of a protein component of the present invention. While processing methods and resulting formulations may vary in manufacturing MF products, MF products of the present invention generally have between 0 to about 0.5% lactose. In one embodiment, incorporation of the these products results in a direct expanded product with a desired light color, having an L-value of about 70, due at least in part to the minimization of Maillard browning reactions in the extruder. In other embodiments, an L-value ranging from between about 62 to about 71 is also desirable and acceptable. In one embodiment, a Micellar casein, having at least about 83% protein is selected for mixing with at least one starch component 10. By way of example and without intending to limit the scope herein, Table 1, below, shows the composition of a suitable Micellar casein for use in the instant invention. As with any organic material, there may be some variation in the chemical composition and the information given is approximate.

TABLE 1
Composition of a suitable Micellar casein

| | |
|---|---|
| Fat % | <1.5 |
| Protein % | 83.0 |
| Moisture % | <5.0 |
| Ash % | 9.5 |
| Lactose % | <0.5 |
| Calcium % | 3.0 |
| Potassium % | 0.3 |
| Phosphorus % | 1.1 |
| Magnesium % | 0.1 |

In another embodiment, an ultrafiltered (UF) dairy product is selected for inclusion into the protein component 10 of the present invention. Despite the additional lactose present in UF dairy products, however, embodiments of the present invention comprising MPIs have been found to exhibit a superior flavor profile when incorporated into a direct expanded product. Further, substitution with a dairy product having a higher percentage of lactose provides for a more cost-effective alternative protein for incorporation into snack foods. That is to say, even with a higher percentage of lactose, the UF dairy products selected in the present invention surprisingly provide for superior flavor and texture in a direct expanded product. This is counterintuitive to what is known in the art due to the higher presence of sugars, which even though seemingly slight, typically have a negative effect when cooking extrudates. It is believed that the positive benefits achieved are due to both the processing conditions and expansion controlling agents of the present invention. Preferably, the UF dairy product selected for preparation of the protein component is a soluble milk protein isolate (MPI). Like MF products, the particular processing technique used to prepare a MPI may affect the composition of protein, fat and lactose. However, generally, for purposes of the present invention, the protein percentage of a selected MPI is about 85% or higher, with low-fat content of less than or equal to about 2%, and a lactose content of no less than approximately 1.7%. In one embodiment, the MPI comprises between about 1.7% to about 2.0% lactose. In another embodiment, a MPI comprises no less than about 1.7%.

Suitable commercially available MPI for use in the dough formulation of the present invention include, for example, Milk Protein Isolate 4900 (also known as ALAPRO™ 4900) available from Fonterra. By way of example and without intent to limit the scope of the invention, Table 2, below, shows the composition of a suitable milk protein isolate for use in the instant invention. As with any organic material, there may be some variation in the chemical composition and the information given is approximate.

TABLE 2
Composition of a suitable milk protein isolate

| | |
|---|---|
| Fat (g/100 g) | 1.7 |
| Protein (g/100 g) | 86.6 |
| Moisture (g/100 g) | 4.5 |
| Ash (g/100g) | 7.1 |
| Total Sugars (lactose) (g/100 g) | 1.7 |
| Calcium (mg/100 g) | 2320 |

In one embodiment, the protein component comprises about 100% of a milk protein isolate. In another embodiment, the protein component comprises at least about 30% of a milk protein isolate. In another embodiment, the protein component comprises at least about 50% of a milk protein isolate. In another embodiment, the protein component comprises between about 30% to about 100% of a milk protein isolate. In one embodiment, the protein component further comprises an additional protein derived from a legume such as soybean. Preferably, the additional protein is a soy protein isolate (SPI) such as, for example, one with mild soy flavor. Suitable commercially available SPI for use in the protein component includes, for example, Supro 620 from The SOLAE™ Company. In one embodiment, the protein component is comprised of from 0 up to about 70% of a SPI, with the remaining portion of the protein component comprising an ultrafiltered dairy product such as milk protein isolate. In another embodiment, the protein component is comprised of about 50% of SPI. In another embodiment, the protein component is comprised of a MPI and a SPI in a ratio of about 50:50. Generally, no more than 70% of the dry mix formulation is comprised of a soy protein isolate.

As starch also contributes to the expansion of a direct expanded product, at least one starch component is combined with the protein component 10. Preferably, when only one starch component is selected for combination, a corn starch or a corn meal is used. Other suitable starch components include without limitation potato starch, tapioca starch, rice starch, wheat starch, or any modified starch, whether alone or in some combination. In one embodiment, the starch comprises about 70% of the dry mix formulation. Embodiments comprising about 70% to about 85% of the dry mix formulation are also possible, resulting in acceptable extruded end products, though these may typically result in lower amounts of protein per serving.

Dry ingredients are then admixed 12 with the protein-starch mixture to form a dry mix formulation, which can be characterized as a homogenous, dry blend powder. Dry ingredients 12 include without limitation fiber, vitamins, minerals and/or any other nutritional supplement. In preferred embodiments, the dry ingredients comprise one or more expansion controlling agents. As used herein, the term expansion controlling agent is meant to refer to the protein manipulating substances described herein that provide for dense, light colored extruded snack products having an L-value of between about 58 to about 71 including a porous calcium carbonate, sodium hexametaphosphate, phosphoric acid, citric acid and other food-grade acids that can accomplish a reduction in pH or other chelating or nucleating agents as used herein. Expansion controlling agents of the present invention allow for the production of direct expanded food products having a more well-defined outer periphery with smaller cell size diameters, which can be described as dense.

While the substantial elimination of fat, minerals and lactose from the MF dairy products reduces Maillard reactions and improves processability for use of these products and their proteins in the production of a direct expanded food product, in the case of UF products, the higher level of lactose typically results in a burned dairy flavor with a glassy texture and large cell bubbles unless the formulation is further manipulated. For example, in embodiments comprising MPI, it has been found that the addition of a porous calcium carbonate results in an improved expansion and texture of the final products as shown in FIGS. 2A and 2B. FIG. 2A depicts the cross section of an expanded MPI product without calcium carbonate. As depicted in FIG. 2B, expanded products comprising a milk protein isolate with calcium carbonate provide for more a well defined outer periphery as well as smaller cells y. During test runs, a trained panel perceived sample 2, shown in FIG. 2B, as dense, while sample 1, shown in FIG. 2A, was perceived as “glassy” and hard and therefore, less desirable. Thirty-four measurements were taken from each sample. The sample without calcium carbonate (sample 1) comprised a larger average cell size diameter of about 0.944 mm with a range of about 0.06 to about 2.2 mm, whereas the sample with calcium carbonate (sample 2) had an average cell size diameter of about 0.657 mm with a range of about 0.24 to about 1.32 mm.

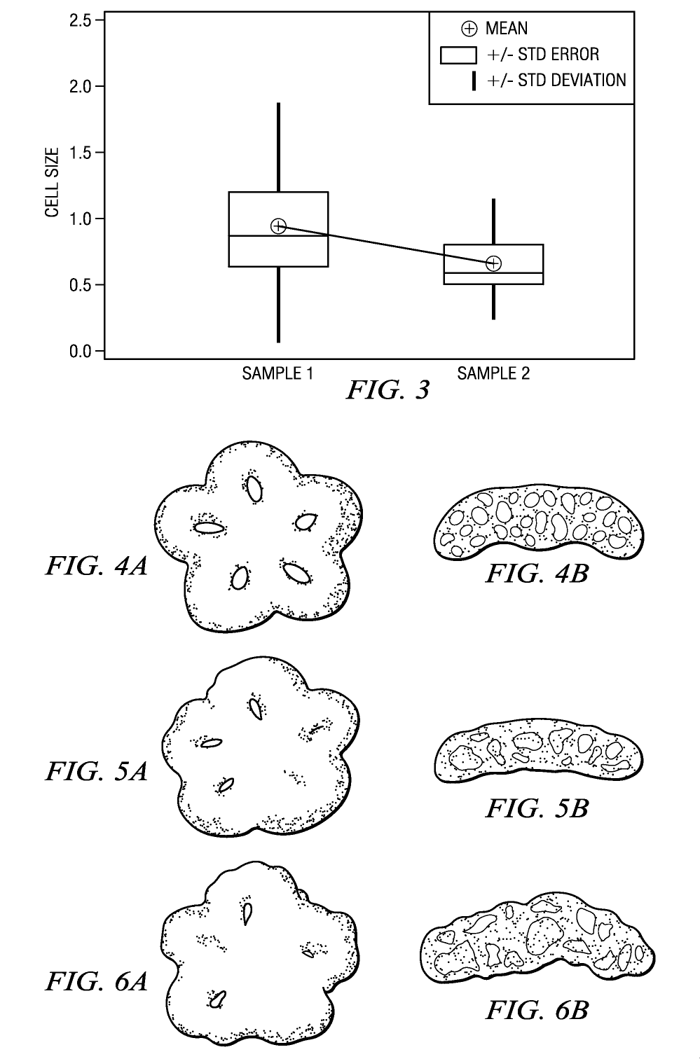

FIG. 3 depicts a t-test graph, comparing the variation of the taken measurements of Samples 1 and 2, shown in FIGS. 2A and 2B. A two sample t-test conducted revealed that the average for the samples of FIGS. 2A and 2B are significantly different, with a p-value of 0.001. Thus, in one embodiment, a porous calcium carbonate is added to the dry mix 12 to manipulate the protein and control the expansion of a protein-based direct expanded product. Without being bounded by theory, it is believed that the porosity of the calcium carbonate is able to generate markedly different textures in the protein extrudates by creating nucleation sites that enable the creation of small air cells, resulting in dense, foamy textures with reduced browning effects. The calcium carbonate may also provide a cross-link for the milk proteins casein and whey to form a larger molecule, providing a more desirable texture, flavor, and expansion. By way of contrast, during test runs, the addition of calcium caseinate did not produce the same improved textural effects as calcium carbonate. Thus, in one embodiment, it is preferable that the dry ingredients are free of calcium caseinate.

Preferably, the calcium carbonate has a particle size of less than about 25 microns. In one embodiment, the particle size is less than about 15 microns. In another embodiment, the particle size is between about 15 and about 25 microns. In a preferred embodiment, in order to obtain the desired texture and color of a puffed product, the dry mix 12 comprises between about 0.9625% to about 1.375% calcium carbonate as an expansion controlling agent to produce an extrudate having a smooth surface and a final puffed product having a very clean flavor. With 1.375% calcium carbonate, expansion is about 25% longer and the diameter is 10% shorter, with a total volume larger than an extrudate comprising MPI alone. During one test run, for example, the length of a resulting extrudate comprising MPI alone was about 52 mm, the diameter was about 12.1 mm and the volume was about 5.98 cubic centimeters. An extrudate comprising both MPI and a calcium carbonate was about 65 mm long, with a diameter of about 11.0 mm and a volume of about 6.18 cubic centimeters. In another embodiment, the dry mix 12 comprises about 1.26% calcium carbonate to produce a denser product. Generally, doughs of the present invention incorporating a calcium carbonate contain approximately 70% to 85% cornmeal starch by weight, approximately 15% to 32% milk protein isolate by weight, and approximately 0.9625-1.375% calcium carbonate by weight. In a further embodiment, no more than 16% of the dry mix formulation is comprised of a soy protein isolate.

A porous calcium carbonate suitable for use herein may be derived from a natural source such as a seaweed or marine extract, in one embodiment. For example, one derived from a Phymatolithon calcareum, which is a calcareous alga having a high amount of minerals, may be used with the present invention to control the expansion, texture and porosity of an extrudate comprising a filtered dairy protein. The calcareum skeleton is mainly composed of carbonated calcium and carbonated magnesium, with the two elements representing about 35% of the plant (dry weight). The source of the porous calcium carbonate may also contain other minerals and trace elements such as phosphorus, potassium, manganese, boron, iodine, zinc, copper, selenium, and cobalt. One natural source for use with the present invention is commercially available, for example, under the trademark AQUAMIN® manufactured by Marigot Ltd. In addition, any known methods of imparting porosity to a calcium carbonate particle may also be suitable for use in another embodiment of the present invention. Thus, a porous calcium carbonate may also be manufactured using any known methods of imparting porosity into particles such as with any food-grade pore-forming agents or other porosity forming technologies suitable for use with food products.

FIGS. 4-6 illustrate the differences in expansion attained during test runs of expanded products containing a filtered dairy protein and a porous calcium carbonate (FIGS. 4A and 4B) and those comprising a filtered dairy protein and no calcium carbonate (FIGS. 5A-6B), all of which were extruded through a flower die to impart a unique flower shape to the product. FIGS. 4A and 4B depict the resulting direct expansion of an extrudate comprising a filtered dairy product with a porous calcium carbonate. As shown in FIG. 4A, expansion at high temperatures as described below results in a well-defined outer and inner periphery and shape of the expanded product, clearly displaying the flower shape of the die used. Further, the cell sizes depicted in cross-section of the expanded product of FIG. 4A, shown in FIG. 4B, illustrate the improved density and shape retention of the product. On the other hand, FIGS. 5A and 5B depict a direct expanded product of the present invention containing a milk protein isolate with no added calcium carbonate. Although not depicted in the illustrations, samples of FIGS. 5A and 5B resulted in an undesirable brown color, due to the presence of lactose in the dairy product. As shown best in FIG. 5A, the inner shape of the flower die is poorly defined and barely visible, versus the extrudate of FIGS. 4A and 4B. In addition, the cross-section shown in FIG. 5B illustrates the glassy nature of the expanded product. Similarly, FIG. 6A depicts a micellar casein product without calcium carbonate. While the coloring of the expansion in FIGS. 6A and 6B was desirably lighter than that of FIGS. 5A and 5B (coloring not depicted), the color was almost transparent when compared to the denser product of FIG. 4A and the resulting expanded product was even more poorly defined as apparent from both FIGS. 6A and 6B, despite the presence of less lactose. Consequently, in some embodiments, extrudates comprising a porous calcium carbonate are direct expanded through any number of shaped dies, including without limitation complex shapes such as a star or flower and simpler shapes such as circular or square. In one embodiment, a dry mix formulation of the present invention comprises between about 70% to about 75% corn meal, about 25% to about 28% MPI, and about 0.9625-1.375% calcium carbonate. In another embodiment, a dry mix may comprise about 45% corn meal and about 20% to about 23% resistant starch. All percentages expressed herein refer to percentages by weight.

Returning to the discussion of FIG. 1, after forming the protein-starch mixture 10 and the addition of dry ingredients with at least one expansion controlling agent 12, other extrusion controlling agents can also be included for improved color, flavor, texture, and/or expansion by reducing the pH of the extrudate in further embodiments of the present invention. In one embodiment, for example, citric acid is added 14 to reduce the pH of the formulation while impacting the protein and casein in the milk protein to become more stretchable. In direct expansion of dairy containing extrudates of the present invention, it has been found that the addition of citric acid helps to maintain or retain the shape of the final puffed product. The addition of citric acid provides for an extrudate having a lighter, more appealing color approximating a desirable L-value and an improved taste and texture, with smaller cell bubbles in the puffed product. In one embodiment, an extrudate comprising 0.5% citric acid is including in the dry mix 12 of the present invention. Test runs demonstrated good extrusion through a flower die to produce a well-defined flower shape. Without being bounded by theory, in addition to reducing the pH of the formulation, the citric acid may also be acting as a chelating agent to impact the calcium in the unique Micellar structure of the MPI, inhibiting Maillard reactions and changing the structure and functionality (cross-linking) of the milk protein during the extrusion process to impact the final texture of the end product. For example, during one test run, the pH of an extrudate having no citric acid was measured to be 6.50. Subsequent addition of 0.5% citric acid resulted in an extrudate having a light color, non-glassy texture, smaller cell bubbles and no burned dairy protein flavor. The pH after addition of 0.5% citric acid was measured to have been reduced to 6.07. It is believed that because casein is a sensitive protein, as the pH decreases, the casein protein begins to coagulate. Casein was also observed to become more extensible at lower pH when heat is applied.

In another embodiment, phosphoric acid 12 is added to the mix in order to impact the pH of a product for a more desirable (lighter) color in a finished product. During trial runs, phosphoric acid was added at levels of 0.094%, 0.19%, 0.38%, and 0.75%. Beginning at 0.19%, some color improvement observed and the pH was reduced from about 6.61 to about 6.25. However, only with the addition of 0.38% phosphoric acid (resulting in a pH of about 5.97), was a desirable light yellow corn colored extrudate with an L-value of about 63.67 produced. At this level, the cells of the finished puffed product were smaller and more evenly sized and the flavor was clean, without a burnt flavor. At addition of 0.75% phosphoric acid, the pH was reduced to about 5.69. The addition of more than 0.75%, while producing a lighter color, produced off-flavor in the final puffed product. Consequently, in one embodiment, between about 0.38% and about 0.75% phosphoric acid by weight is added to produce the desired product with smaller cells, having a more even size and a clean flavor. In another embodiment, 0.38% phosphoric acid is added. Citric acid or other acids capable of reducing the pH may also be suitable. In one embodiment the pH is reduced to between about 5.5 to about 6.3. It is believed that by manipulating the pH of the dough prior to extrusion, the acid may help control the undesired reactions during extrusion to produce a finished product with good color as well as good expansion. Phosphoric acid may be incorporated as a dry ingredient in forming the dry mix 12 or into the water-based solution 14, discussed further below. For example, during trial runs, the phosphoric acid was diluted to 5×, and pumped to the feeder by a calibrated peristaltic pump. Addition of water to the extruder barrel was adjusted according to the water included in the diluted phosphoric acid. In further embodiments, other food grade acids may be added to affect the pH and the final shape of a puffed dairy-containing extrudate.

In another embodiment, no more than 0.5% sodium hexametaphosphate is included in the dry mix 30 in order to create a final product having a crunchy texture. It is believed that hexametaphosphate may also act as a chelating agent, preventing reaction of trace metals ions that can otherwise have a negative impact on color, flavor, and texture. During test runs, addition of about 0.5% sodium hexametaphosphate to the dry mix comprising Micellar casein resulted in an extrudate with a white color, smooth texture, even cell size, and clean flavor. In further embodiments, other food grade chelating agents may also be added to improve the color, texture and flavor of the resulting puffed product.

Having described the embodiments for suitable formulations of the present invention for step 12 of FIG. 1, the dry mix can then be introduced into an extruder and preconditioned with a water-based solution 14 in preparation for extrusion 16. Once introduced into an extruder 16, a sufficient amount of a water-based solution 14 is added to the dry mix to form extrudate dough having a moisture content of about 17% to about 21%. The preconditioned dough is then extruded at a mix feed rate of between about 400-500 lbs/hr for direct expansion 16. Preferably, a twin-screw extruder is used to enable continuous mixing of the ingredients and subsequent extrusion through a die plate. It has been found advantageous to use a twin screw extruder that is capable of providing multiple zones with differing temperatures to ensure proper mixing, cooking and kneading of the dough as well as subsequent expansion. For example, a twin screw extruder having five barrel zones, such as a BC-45 model manufactured by Clextral, may be employed, adding water to hydrate the dry ingredients within the extruder. During test runs, pre-hydrated dough was first fed into a first zone and advanced by the action of the extruder in a continuous stream to flow through five barrel zones. In one embodiment, the first barrel zone is set at about 90° F., the second barrel zone is set at about 200° F., the third barrel zone is set at about 200° F., the fourth barrel zone is set at about 250° F., and the fifth barrel zone is set at about 300° F. Significantly, in the prior art, the screw speed for higher protein products is typically run at a lower settings of below about 350 rpm, along with lower temperatures, and lower pressures for less damage to the proteins. However, in the present invention it has been found that the porosity, cell-size, and texture of a puffed product is actually improved, resulting in superior taste, mouth feel and crunchiness with higher screw speed temperatures. Thus, in one embodiment a screw speed of at least about 380 is used to result in an extrudate temperature upon exit from the die of about 370° F. In another embodiment, a screw speed of at least 400 rpm used for an extrudate temperature of about 390° F. upon exit from the die. In another embodiment, a screw speed of between about 400-425 rpm is used for an extrudate temperature of between about 390° F. to about 398° F. upon exit from the die. In some embodiments, a heating band may be used to keep the temperature greater than 390° F. Applicants found that these higher temperatures and speeds actually improve the expansion of the end resulting food product. In addition to maintaining higher speeds, higher temperatures are also thought to contribute to a better expansion, as the temperature of the extrudate is a function of the screw speed. In order to produce a puffed ready-to-eat food product through direct expansion, extrusion must be performed at a pressure of at least about 1200 psi and the extrudate must exit the extruder die at a temperature of about 370° F. to about 400° F. Above temperatures of about 400° F., the products tend to burn. Conversely, temperatures of less than between about 340° F. to about 350° F. will not produce sufficient expansion to form a puffed snack food product with a crunchy texture. In one embodiment, barrel pressures of between about 1200 and about 1400 psi are used with the present invention. Preferably, pressures of between about 1350 psi and about 1400 psi are utilized.

Following extrusion 16, the puffed products are cut 18 and can then be further dried 20 to reduce the moisture down from about 5-9.5% to less than 2%, forming ready-to-eat, shelf-stable puffed end products. Drying 20 can be performed by any means known in the art. For example, in one embodiment, the product is dried 22 using a hot air dryer. Once dried, the products may be flavored or seasoned 22 by any means known in the art, including without limitation spraying with seasoning oil and application of a cheese powder seasoning blend.

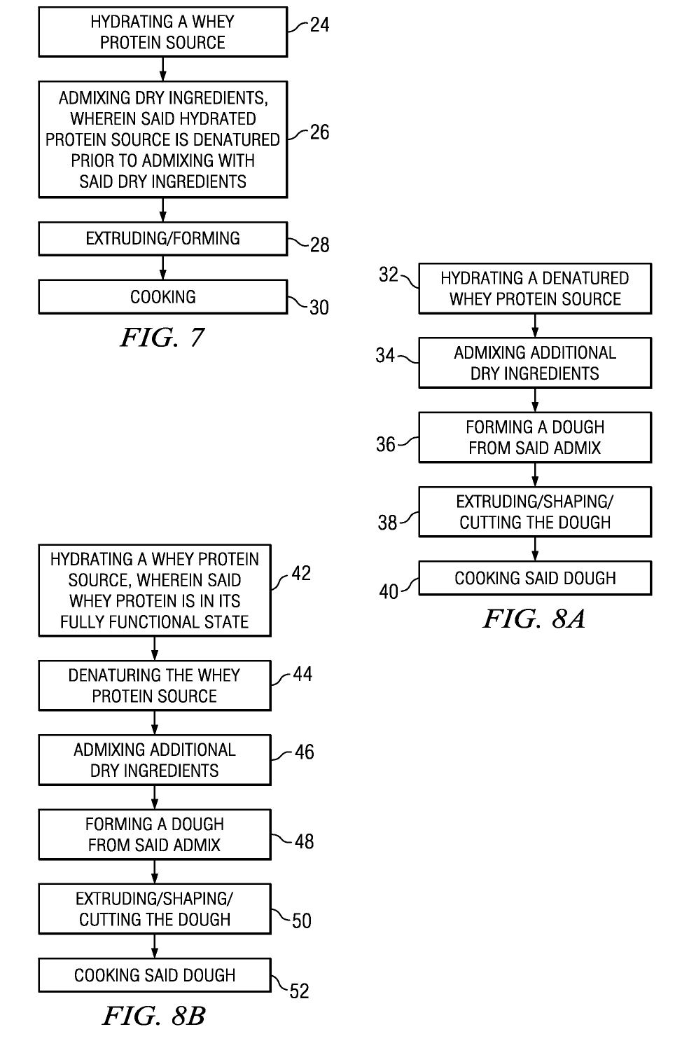

A second aspect of the present invention is depicted in FIG. 7, relating to another embodiment of snack foods containing proteins and in particular, a method for manufacturing shelf-stable ready-to-eat food products containing dairy or whey proteins via cold extrusion or cold extrusion-type processes. As previously stated, doughs incorporating whey proteins result in sticky and therefore, unsheetable doughs. In order to prevent sticky doughs when incorporating a whey protein source, a whey protein source is preferably in a denatured state, or defunctionalized, prior to its combination with dry ingredients. In this manner, an improved dough having less cohesion that does not adhere to the surfaces of the sheeting and/or forming equipment is formed. Without intending to limit the invention to any theory, it is believed that with denatured protein, the structure unfolds, enabling it to better retain water without resulting in an adhesive dough that is otherwise difficult to combine with other dry ingredients and difficult to work with when forming and sheeting the dough. In contrast, when whey proteins in their non-denatured state were utilized during test runs for protein inclusion in making the dough for pretzels and/or other baked products, the doughs were very sticky and were not able to be sheeted for subsequent cold extrusion processes.

FIG. 7 depicts an overall flowchart of the present invention as it pertains to the formation of a sheetable whey-based dough for cold extrusion or cold extrusion-type processes such as pretzels and crackers. Unlike the puffed, direct expanded products described above (with reference to the method of FIG. 1), the products that undergo cold extrusion-type processes of the present invention are extruded through an extruder and die at room temperatures, without the application of heat and/or high pressures. In addition, unlike direct expansion processes, formation of the dough takes place prior to introduction into an extruder or former, rather than within the extruder. Consequently, the need for a sheetable dough, which is easy to handle and work with prior to introduction into an extruder or former, is important when attempting to make use of a cold-extrusion process.

With reference to FIG. 7, in a first step 24 in the incorporation of a whey protein and the formation of a protein-containing dough, a whey protein source is hydrated or soaked 24 in water. A suitable whey protein source or component, in one embodiment, may be provided by a powdered whey protein concentrate, a whey protein isolate, or any combination thereof. In one embodiment, a suitable whey protein source is one comprising at least 60% protein, wherein said protein consists of whey protein concentrate, whey protein isolate, or any combination thereof. In another embodiment, a whey protein concentrate comprising at least about 80% protein is used with the present invention. Preferably, the whey protein source is in solid, or dry, form. In one embodiment, a suitable whey protein source is one that has been fully denatured. Thus, in one embodiment, a pre-manufactured crisp, for example, which comprises protein that has been denatured or defunctionalized, is soaked 24. One such example of a whey protein source already in a denatured state is a dairy crisp known as “Dairy Protein Crisp 6001” manufactured by Fonterra. In another embodiment, a suitable protein is in its native functional (soluble) state when soaked 24. Thus, the present invention also allows for a whey protein source in its fully functional state to be selected for hydration in one embodiment.

A whey protein source is preferably hydrated or soaked 24 in sufficient water to hydrate or soften the dry component. Thus, in one embodiment, a denatured whey protein source is soaked or hydrated 24 until its texture becomes soft. In one embodiment, a sufficient amount of water is added so as to form a whey protein solution. A whey protein solution is preferable in some embodiments such that a whey protein source can be combined with dry ingredients in forming a dough of a desired consistency. For example, in one test run, about 40 grams of a whey protein concentrate were added to about 110 grams of water to sufficiently hydrate the whey protein source 24. It has been found by Applicants that hydrating a whey protein source produces a whey protein solution that can be easily incorporated together with additional dry ingredients for the production of a manageable, non-sticky dough, without any abrasive steps such as grinding, milling or the like. In one embodiment, soaking the whey protein actually allows for the subsequent admix of additional dry ingredients by softening a denatured whey protein source to the point where it is soft enough to add further ingredients without the need for grinding, heating or pH-reducing steps. In another embodiment, soaking the whey protein allows for simple denaturation by the application of heat to the whey protein solution for a short period of time, without the need for any further components that may change the pH or alter the protein or its interactions with the additional ingredients in forming a desirable dough for cold extrusion processes.

Following hydration 24, it is preferable that the whey protein source contain whey in a denatured state prior to its combination with further additional dry ingredients 26. Thus, the present invention depends on the selection of the whey protein source. In one embodiment wherein the whey protein source is in it fully functional state prior to hydration 24, the whey protein source is denatured subsequent to the hydrating step 24 and prior to admixing the additional dry ingredients. In one embodiment, they whey protein source is denatured using high temperatures of between about 80° C. to 85° C. In another embodiment, the whey protein is heated to about 85° C. Denaturation by heating causes changes in the stereostructure at secondary, tertiary, or quarternary level without destruction of a peptide linkage contained in its primary structure and aggregates the denatured molecules to regularly form a network structure of the protein. While the proteins should begin to denature at about 65° C., during test runs, the protein source was microwaved for about 30 seconds to a range of between about 80° C. to about 85° C. in order to ensure complete denaturation of the main components of whey protein, wherein 100% of both beta-lactoglobulin and alpha-lactalbumin have been denatured. About 72% of the protein in whey has the ability to denature, with the rest being nitrogen components of small peptides that cannot be denatured.

In one embodiment, the hydrated whey protein source 24 or whey protein solution is heated by microwaving the hydrated whey to denature the whey protein. In further embodiments, the solution is heated by any other means known in the art to reach the necessary temperature for complete denaturation. In one embodiment, the whey protein solution is heated to at least about 80° C. in order to ensure that all whey proteins are significantly denatured such that about 100% of the protein's main components, beta-lactoglobulin and alpha-lactalbumin, have been denatured prior to admixing the denatured whey protein with additional dry ingredients. In another embodiment, the denatured whey protein source, such as one which has already undergone substantial denaturation is soaked until, need only be hydrated until softened 24 and may then be combined with additional dry ingredients 26. Manipulation of the denaturation properties of the whey in this manner results in a sheetable whey-based dough, which is easily manageable for sheeting and forming, cold extrusion, or cold extrusion-type processes.

Returning to the discussion of FIG. 7, following the hydrating of a whey protein source 24, the method comprises admixing dry ingredients with the hydrated whey protein, or whey protein solution 26, wherein said hydrated protein is denatured prior to admixing with said dry ingredients. It is preferred that embodiments wherein the whey solution must be heated to denature the whey protein, such heating is performed prior to the admixing 26 and subsequent to the hydration of the whey protein source 24. Denaturation or defunctionalization of the whey protein should be accomplished separate from the other dry ingredients used to form the whey-based dough such that none of admixed dry ingredients are affected by the application of heat prior to formation of the extrudate. Dry ingredients may comprise any number of components in the creation of a sheetable whey-containing dough. Suitable dry ingredients include, for example, wheat, oat, rice, whole grain oat flour, fiber, additional dairy and/or soy proteins such as milk protein isolates and soy protein isolates and concentrates or any variety of cheeses, calcium, and/or any vitamin, mineral or other nutritional supplement or additive as well as any combination of these ingredients.

In preferred embodiments, the admixed ingredients 26 comprise at least about 20% protein, at least half of which comes from a whey protein. In one embodiment, 100% of the whey protein source comes from a powdered whey protein concentrate. In one embodiment, the whey protein source comprises about a 50:50 ratio mixture of a whey protein concentrate and a secondary protein source such as a soy protein isolate for a milk protein isolate. In one embodiment, the whey protein source comprises about 75% whey protein concentrate and about 25% soy protein isolate. Suitable dry ingredients include, for example, at least 10-20% of one or more starch components and about 30% of one or more grains, and small amounts of sugars, fibers and/or sodium bicarbonate. Optionally, small amounts of oil may also be desired if subsequent baking or frying methods dictate such additions. During one test run, a suitable embodiment of the admixed formulation was found to comprise, for example, between about 15% to about 18.5% ground whole grain, about 15% to about 18.5% oat flour, about 4.5% to about 6% rice flour, about 10.5% to about 12.5% whey protein concentrate, between about 9% to about 11% of a secondary protein source such as soy protein or another dairy protein derived from milk, about 4% to about 5% sugar, about 4% to about 4.5% fiber, about 0.5% to about 0.8% sodium bicarbonate, about 9% to about 10.5% modified starch, about 6% to about 7% corn oil, and about 0.3% ammonium bicarbonate. In another test run a suitable embodiment of the admixed formulation was found to comprise between about 17.5% to about 18.5% ground whole grain, between about 17.5% to about 18.5% oat flour, about 5.5% to about 5.8% rice flour, about 4% to about 5% sugar, about 4% to about 4.8% fiber, about 9% to about 10.5% modified starch, about 0.5% to about 0.8% sodium bicarbonate, about 1.3% to about 2.4% soy lecithin, about 0.7% to about 0.8% monocalcium phospate, about 21.5% to about 24.8% whey protein concentrate, about 6.1% to about 7% corn oil, and about 0.3% ammonium bicarbonate. All values should be understood to be approximate values and are meant to indicate the percentage by weight. These embodiments are meant to provide example formulations and are not meant to limit the scope of the present invention, unless otherwise indicated.

Returning again to the flowchart of FIG. 7, upon the admixing of the hydrated whey protein source with other dry ingredients 26, a whey-based dough is formed. By utilizing either heat to denature the whey protein or choosing an already denatured, pre-manufactured whey protein source, cohesive doughs are produced that are easily manipulated and managed for the production of snack products. In addition, small amounts of an oil component may be added to prepare the dough for subsequent cooking steps. The dough can then be extruded or shaped 28 using cold extrusion or any cold extrusion-type process. Optionally, the products may be further shaped or configured as desired using additional forming processes or known methods. For example, during test runs, the dough was formed into a pretzel shape. Further like embodiments or shaping methods can also be utilized. Following extrusion or shaping 28, the formed dough is cooked 30 by means such as baking or frying. Baked embodiments can comprise a maximum of about 15% to about 20% of an oil component. Fried embodiments can comprise a maximum of between about 30% to about 35% of an oil component. After cooking, the cooked product may further optionally undergo a cutting step for reducing the size of the cooked product into snack-sized portions. Seasoning and/or packaging steps may then follow to prepare the product for transport, sale or consumption.

In one embodiment, the whey-based dough undergoes a cold (forming) extrusion 28, followed by either conventional baking 30 delivering low expansion, pretzel-type textures. In another embodiment, created whey-based doughs can be sheeted 28, following by cooking 30 with a convection oven to produce moderately expanded products with a cracker crisp-like texture. In another embodiment, cold (forming) extrusion 28 may be employed followed by convection oven cooking 30 to create a snack food product having a hard cracker like texture. In yet another embodiment, the easily manipulated whey-based dough of the present invention can undergo lamination 28 followed by cooking 30 in a cracker (conventional) oven to produce a typical cracker texture. Thus, the present invention allows for a wide variety of highly nutritional products and an array of desirable textures, including without limitation pretzels and crackers, having good source of multigrain, proteins, fibers and mineral supplements. The total calories do not exceed 140 calories per serving, total fat does not exceed 35% of the total caloric contribution, sodium levels do not exceed 230 mg per serving, and saturated fats do not exceed 10% of caloric contribution.

FIGS. 8A and 8B illustrate two embodiments of the method relating to FIG. 7. In one embodiment depicted as FIG. 8A, a denatured whey protein source is hydrated 32 to soften without any harsh steps such as grinding, milling or granulating the protein source. Once the denatured whey protein is hydrated or soaked for sufficient amount of time so as to soften the source 32, additional ingredients may be added as desired 34. Preferably, the additional ingredients admixed are in some powdered or dried format so as to capture remaining amounts of water into the mix and form a dough. After forming the admix into a dough 36, the dough may be extruded using cold extrusion methods or formed by any other means such as sheeting or shaping 38. Extruded or shaped dough 38 may then be cooked 40 such as by baking in one or more ovens or by frying methods. Optionally, cooked product may be cut into snack size portions either before or after cooking steps. In another embodiment, as depicted in FIG. 8B, a whey protein source in its fully functional state may be hydrated or soaked with water 42 to form a whey protein solution. The whey protein solution may then be denatured 44 such as by heating. In one embodiment, the solution is microwaved for not more than 30 seconds to achieve sufficient denaturation 44. Additional ingredients are then added 46 as desired to forming a sheetable dough 48, which is easily handled and can be fed to a cold extruder 50 for forming or shaping as desired. Formed or shaped dough may then be cooked 52 such as by baking or frying, as previously discussed.

The end result of the methods described herein with relation to FIGS. 1 and 7 are snack products having at least 5 grams of a good source of dairy protein per 1 ounce serving and between about 4 to about 5 grams of fat with about 130 calories per serving. The invention illustratively disclosed herein suitably may be practiced in the absence of any element which is not specifically disclosed herein. It will be understood by those skilled in the art that various changes in form and detail of the admixed ingredients and formulations may be made therein without departing from the scope of the claimed subject matter. For example, components including without limitation flavours, oils, and food colorings may be present in the formulations of the doughs for the present invention to the extent these would not interfere with the desired expansion properties of the doughs.

What is claimed is:

1. A method for incorporating protein into a puffed snack food product comprising the steps of:
mixing a protein component comprised of at least one filtered dairy protein with a starch;
admixing dry ingredients with said protein-starch mixture to form a dry mix, wherein at least one of said dry ingredients is an expansion controlling agent;
adding a water-based solution to the dry mix to form an extrudate dough; and
extruding said extrudate dough to form a direct expanded snack food product.

2. The method of claim 1, wherein said extruding step is performed at a pressure of at least about 1200 psi.

3. The method of claim 1, wherein extruding step is performed at a screw speed of at least about 380 rpm.

4. The method of claim 1, wherein said extrudate comprises a temperature of at least about 370° F. upon exiting from a die at an exit end of an extruder.

5. The method of claim 1, wherein at least 30% of said protein component is comprised of an ultrafiltered dairy product.

6. The method of claim 5, wherein said ultrafiltered dairy product is a milk protein isolate having no less than about 1.7% lactose.

7. The method of claim 1, wherein said expansion controlling agent is a porous calcium carbonate.

8. The method of claim 7, wherein said dry mix comprises between about 0.9625% to about 1.375% calcium carbonate.

9. The method of claim 7, wherein said dry mix comprises about 1.26% calcium carbonate.

10. The method of claim 1, wherein said protein component comprises about 50% of a milk protein isolate.

11. The method of claim 1, wherein said dry mix comprises from about 15% to about 32% of an ultrafiltered dairy product.

12. The method of claim 1, wherein said protein component further comprises up to about 70% of a soy protein isolate.

13. The method of claim 1, wherein said protein component is comprised of a milk protein isolate and a soy protein isolate in a ratio of about 50:50.

14. The method of claim 1, wherein said dry mix comprises 0.5% citric acid.

15. The method of claim 1, wherein said dry mix comprises from between about 0.38% to about 0.75% phosphoric acid.

16. The method of claim 1, wherein said direct expanded snack food product comprises an average cell size diameter of about 0.657 mm.

17. The method of claim 1, wherein said starch component comprises corn meal.

18. The method of claim 1, wherein said starch component comprises a tapioca.

19. The method of claim 3, wherein said milk protein isolate comprises between about 1.7% to about 3% lactose.

20. A product made according to the method of claim 1.

21. A direct expanded ready-to-eat product comprising a starch and at least one filtered dairy product, said direct expanded product further comprising one or more expansion controlling agents, wherein said product delivers at least 5 grams of protein per 1 ounce serving size.

22. The direct expanded product of claim 21 wherein said expansion controlling agent is a porous calcium carbonate.

23. The direct expanded product of claim 21 wherein said expansion controlling agent provides for an average cell size diameter of about 0.657 mm.

24. The direct expanded product of claim 21 wherein said filtered dairy product comprises no less than about 1.7% lactose.

25. The direct expanded product of claim 21 wherein said filtered dairy product is a milk protein isolate.

26. The direct expanded product of claim 21 further comprising a soy protein isolate wherein the ratio of the filtered dairy product and the soy protein isolate is about 50:50.

27. The direct expanded product of claim 21 wherein said expansion controlling agent is a pH-reducing agent.

28. The direct expanded product of claim 21 wherein said expansion controlling agent is selected from the group consisting of phosphoric acid, citric acid and sodium hexametaphosphate.

29. A method for incorporating a whey protein into a dough for sheeting in the production of a snack food product comprising the steps of:
hydrating a whey protein source;
admixing dry ingredients with said hydrated whey protein source, wherein said hydrated protein source is denatured prior to admixing with said dry ingredients; and
forming a sheetable dough with said admix.

30. The method of claim 29, further comprising the step of denaturing the whey protein source following said hydrating step.

31. The method of claim 29, further comprising the step of extruding the dough.

32. The method of claim 29, further comprising the step of cooking the dough.

33. The method of claim 29, wherein said provided whey protein source comprises 100% of a powdered whey protein.

34. The method of claim 29, wherein said whey protein source denatured prior to said hydrating step.

35. The method of claim 30, wherein said denaturing is performed by heating said whey protein source.

36. The method of claim 29, wherein said dry ingredients comprise one or more of:
flour, sugar and leavening agents.

37. The method of claim 29, wherein said forming step further comprises the adding of vegetable oil.

38. A product made according to claim 29.

39. A snack food product comprising:
about 10% to about 20% of a whey protein component;
at least 30% of a grain component; and
between about 15% to about 20% of an oil component.

40. The snack food product of claim 39 wherein said product further comprises between about 10% of a whey protein source and about 9% to about 11% of a secondary protein source.

41. The snack food product of claim 40 wherein said secondary protein source is a soy protein.

42. The snack food product of claim 39 wherein said secondary protein source is an additional dairy protein source.

43. The snack food product of claim 39 further comprising:
about 15% to about 18.5% ground whole grain;
about 15% to about 18.5% oat flour; and
about 4.5% to about 6% rice flour.
